(19) United States
(12) Patent Application Publication
(10) Pub. No.: US 2006/0045937 A1
(43) Pub. Date: Mar. 2, 2006

(54) Food bar

(75) Inventors: Alan John Slesinski, Denville, NJ (US); Earl Carroll Eichelberger, Warwick, NY (US); Kevin Thomas Faughnan, Somerset, NJ (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Unilever Bestfoods North America, Division of Conopco, Inc.

(21) Appl. No.: 10/928,811

(22) Filed: Aug. 27, 2004

(51) Int. Cl. A23L 1/36

(52) U.S. Cl. 426/93

(57) ABSTRACT

A snack or other food bar which includes at least two filling layers directly adjacent each other. Preferably one or more of the filling layers comprise a peanut creme specially adapted to the invention. When a layer of the peanut creme of the invention is deposited, it sets up quickly permitting the deposit of an additional layer thereon without impairing the texture of either layer. The result is a bar having a texture similar to that of peanut butter, in contrast to most previous bars which have lacked the organoleptic impact of peanut butter. The peanut creme is readily processable and physically stable. While the peanut creme layer sets up firmly when deposited in the molten state, it yields a desirable creamy texture in the final product

### BACKGROUND OF THE INVENTION

Snack and nutrition bars are popular and convenient foods for satisfying hunger and for providing an energy boost. Unfortunately, many bars are lacking in organoleptic properties.

Peanut butter is a nutritious food which is popular among children and adults alike. While suitable for snacks, it may include nutritionally valuable components such as Vitamin E, niacin and fiber.

Owing largely to its relatively high liquid oil content, when incorporated into a snack, bakery product, etc., peanut butter is difficult to process in a manner wherein good organoleptic properties, such as creamy texture and peanut butter flavor, are retained. Indeed, in the best of circumstances, creamy texture is difficult to attain and maintain in peanut butter and peanut butter-type spreads. It would be desirable, therefore, to design a peanut butter-containing snack bar with good organoleptic properties and which can be readily prepared.

Froseth et al. U.S. Pat. No. 6,592,915 is directed to a layered cereal bar with at least two cereal layers having identifiable ready-to-eat cereal pieces and at least one visible filling layer between the cereal layers. The cereal layer may be comprised of a cereal composition, high protein rice pieces, a binder and texturized vegetable protein. Granola is mentioned. The filling layer may be a confectionery center which is high in milk content and possesses a relatively low water activity. It can be any type of creamy or chunky layer, including but not limited to any type of peanut butter layer, chocolate layer, frosting layer, honey layer, yogurt layer, gelatin layer, fruit filling layer, and so forth. Froseth et al. indicates that the filling layer can also be made with any other suitable foods or food combinations, including any type of additive. Examples include cereals and cereal pieces, granola pieces, nuggets, nuts, nut pieces, marshmallows, marshmallow bits, peanut butter or butterscotch chips, dried whole fruits, fruit parts, dried fruit products, fruit products such as fruit syrups and so forth.

In one embodiment, Froseth et al's binder is described as a complex carbohydrate binder made from soy protein, fat, sweeteners, water and gelatin. In another embodiment there are 4 to 5 or more total layers which may include one or more additional cereal and/or creamy filling layers. A topping layer may also be present in addition to the filling layer. The topping may be a frosting covering the entire surface of the bar. The layered cereal bar can be partly or completely enrobed in chocolate.

Foseth et al. also describe a method for manufacturing a layered cereal bar. The process includes mixing a binder with a cereal composition having identifiable cereal pieces to form an amorphous mass, compressing the mass into first and second layers, applying a filling layer on the first layer, pressing the first layer, filled layer and second layer together, and cutting the pressed layers into individual cereal bars. An apparatus for manufacturing a cereal bar is also described.

The Froseth et al. bar is said to have excellent storage stability properties. The water activity is said to be in the range of 0.35 to 0.55 and the finished product is said to have a crisp texture which does not crystallize and dry out or become soft and stale. Use of a carbohydrate binder is said to slow moisture uptake, which can cause textural defects. In a specific embodiment, the water activity of the milk filling layer is about 0.25 to 0.35.

Halladay et al. U.S. Pat. No. 3,821,443 is directed to a cereal bar based on corn flakes, puffed rice and wheat flakes. The bar contains at least one layer composed of a farinaceous ingredient and at least one layer composed of a nutritious filling composition.

Viera et al. U.S. Pat. No. 3,917,861 is directed to a nutritious, laminated multiphased food which includes a plurality of discrete layers, at least one of which has cereal particles bonded together by a fat based binder system, the mixture being gradually compacted in an acute angle formed between endless planar belts. An object is avoidance of migration of the binder. A layer is formed and cooled to ambient temperature whereafter a filling may be deposited on the layer and a second layer deposited on the filling. Optional additives or variations may be used in the filler, such as peanut butter, dried fruit such as freeze dried peaches and strawberries, marshmallow, caramel, nut meats and the like. In the case of certain nut spreads like peanut butter, they may be incorporated with the binder as part of the cereal layer.

Rollins et al. U.S. Pat. No. 6,110,511 discloses an edible carrier said to retain a color or flavoring agent when added to a high moisture medium such as a dough or batter. Particles of the invention may be added to a granola bar. Fiber may be derived from sources such as nut.

Shifferaw et al. U.S. Pat. No. 6,139,884 is directed to a high energy food product consisting primarily of an admixture of barley, flax and teff, and a binder which holds the admixture together. The binder includes corn syrup, honey, canola oil and ground sunflower seeds. The flax seeds are a source of calcium, iron, niacin, phosphorus, Vitamin E and omega-3 fatty acid.

Jindra, et al. U.S. Pat. No. 6,528,104 is directed to a flavored filling having a low water activity. The filling can be fruit filling or a filling that includes substantially little or no fruit. The filling is formulated to have a high solids content and a low water activity. Among other fillings mentioned are marshmallow fillings and peanut butter fillings. The filling may include edible oil and humectant to achieve the low water activity of the filling, and it may also include a starch such as a flour, an emulsifier, and vitamins and minerals such as vitamins A, and E, and various B and D vitamins. The filling is cooled before being packaged. Granola and cereal bars are mentioned.

Manning et al. U.S. Pat. No. 6,576,253 discloses a food bar including DHA and one or more DHA masking agents. It is said that as a result of the DHA masking agents, the food bar may taste like various foods such as peanut butter, marshmallow and various fruit flavors. The moisture content of the bars is generally from 0 to 3%, preferably from 0 to 1.5%. A wide variety of vitamins and minerals may be included in the food bar. The bars are preferably prepared by separately producing a binder, a base and a top layer, the base is then extruded and the top layer is placed on top. The resulting bar is then coated on the top, bottom and all sides with a coating.

Odland, et al. EP 178 074 is directed to a shelf-stable food product such as a granola bar which includes a thermoplastic, low water activity binder matrix comprising a gelled solution of gelatin in glycerol. The product is said to be highly resistant to the migration of moisture between individual food component regions. The granola mix may include peanuts.

Prosise et al. U.S. Patent Application Publication Nos. U.S. 2002/0015761, 2003/0054089 and U.S. 2002/0094359 disclose nutritious foods said to offer an alternative to unhealthful snacks. Examples include peanut-filled bars and crackers. Amino acid sources which can be used include plant proteins. Examples of useful seed protein materials include soy flour, soy protein concentrate, soy protein isolate, peanut flour and mixtures thereof. In peanut butter making procedure PNB#2, defatted peanut flour is added.

Kelly et al. U.S. Pat. No. 4,055,669 discloses a high protein, fat occluded food composition useful as a binder and a food or breakfast bar prepared therefrom.

EP 325 479 is directed to shaped foods made by shaping and binding granules of cereal food.

Ode U.S. Pat. No. 3,903,308 is directed to a food bar and method of making. The food bar is prepared by toasting grain bound into a coherent unit by a binder consisting of a sweetened, low moisture whole milk product. Granola is mentioned.

Kretchman et al. U.S. Pat. No. 6,004,596 discloses a sealed crustless sandwich. Upper and lower fillings are preferably comprised of peanut butter and a center filling is comprised of at least jelly. The center filling is said to be prevented from radiating outwardly into and through the bread portions from the surrounding peanut butter.

Other patents disclosing layered bars include Manning et al. U.S. Pat. No. 6,569,445 and Funk et al. U.S. Design Pat. No. D478,704.

### SUMMARY OF THE INVENTION

The present invention is directed to a snack or other food bar which includes at least two filling layers directly adjacent each other. Preferably one or more of the filling layers comprise a peanut creme specially adapted to the invention. When a layer of the peanut creme of the invention is deposited, it sets up quickly permitting the deposit of an additional layer thereon without impairing the texture of either layer. The result is a bar having a texture similar to that of peanut butter, in contrast to most previous bars which have lacked the organoleptic impact of peanut butter. The peanut creme is readily processable and physically stable. While the peanut creme layer sets up firmly when deposited in the molten state, it yields a desirable creamy texture in the final product.

The peanut or other nut creme according to the invention will typically comprise at least 50 wt % peanuts, optionally vegetable oils, and optionally seasoning and/or stabilizing ingredients, the ingredients being ground into a creme which has
a) at a temperature of 32° C.,
i) a viscosity of at least 50,000 cps at a shear rate of 1 s⁻¹,
ii) a viscosity of at least 10,000 cps at a shear rate of 10 s⁻¹,
iii) a viscosity of at least 7,000 cps at a shear rate of 30 s⁻¹, and
iv) a viscosity of at least 6,000 cps at a shear rate of 60 s⁻¹,
b) at a temperature of 54° C.,
i) a viscosity of at least 17,000 cps at a shear rate of 1 s⁻¹
ii) a viscosity of at least 4,000 cps at a shear rate of 10 s^{-1,}
iii) a viscosity of at least 2,400 cps at a shear rate of 30 s^{-1,}
iv) a viscosity of at least 2,100 cps at a shear rate of 60 s⁻¹, and
c) at a temperature of 71° C.,
i) a viscosity of at least 20,000 cps at a shear rate of 1 s⁻¹
i) a viscosity of at least 3,400 cps at a shear rate of 10 s⁻¹,
ii) a viscosity of at least 2000 cps at a shear rate of 30 s⁻¹, and
iii) a viscosity of at least 1600 cps at a shear rate of 60 s⁻¹.

Preferably, the peanut creme is a peanut butter according to the FDA Standards of Identity cited below.

More preferably, the peanut creme has
a) at a temperature of 32° C.,
i) a viscosity of at least 70,000 cps at a shear rate of 1 s⁻¹,
ii) a viscosity of at least 15,000 cps at a shear rate of 10 s⁻¹,
iii) a viscosity of at least 8,000 cps at a shear rate of 30 s⁻¹, and
iv) a viscosity of at least 7,000 cps at a shear rate of 60 s^{-1,}
b) at a temperature of 54° C.,
i) a viscosity of at least 21,000 cps at a shear rate of 1 s⁻¹
ii) a viscosity of at least 5,400 cps at a shear rate of 10 s⁻¹
iii) a viscosity of at least 3,400 cps at a shear rate of 30 s⁻¹, and
iv) a viscosity of at least 2,400 cps at a shear rate of 60 s⁻¹, and
c) at a temperature of 71° C.,
i) a viscosity of at least 24,000 cps at a shear rate of 1 s⁻¹,
i) a viscosity of at least 4400 cps at a shear rate of 10 s⁻¹,
ii) a viscosity of at least 2400 cps at a shear rate of 30 s⁻¹, and
iii) a viscosity of at least 2000 cps at a shear rate of 60 s⁻¹.

Still more preferably, the peanut creme has
a) at a temperature of 32° C.,
i) a viscosity of at least 100,000 cps at a shear rate of 1 s⁻¹
ii) a viscosity of at least 24,000 cps at a shear rate of 10 s⁻¹,
iii) a viscosity of at least 10,000 cps at a shear rate of 30 s⁻¹, and
iv) a viscosity of at least 8,000 cps at a shear rate of 60 s⁻¹,
b) at a temperature of 54° C.,
i) a viscosity of at least 30,000 cps at a shear rate of 1 s⁻¹,
ii) a viscosity of at least 6,500 cps at a shear rate of 10 s⁻¹,
iii) a viscosity of at least 4,400 cps at a shear rate of 30 s⁻¹, and
iv) a viscosity of at least 3,400 cps at a shear rate of 60 s⁻¹, and
c) at a temperature of 71° C.,
i) a viscosity of at least 34000 cps at a shear rate of 1 s⁻¹
ii) a viscosity of at least 6000 cps at a shear rate of 10 s⁻¹,
iii) a viscosity of at least 3000 cps at a shear rate of 30 s⁻¹, and
iv) a viscosity of at least 2400 cps at a shear rate of 60 s⁻¹.

Most preferably, the peanut or other nut creme has
a) at a temperature of 32° C.,
i) a viscosity of at least 140,000 cps at a shear rate of 1 s⁻¹
ii) a viscosity of at least 34,000 cps at a shear rate of 10 s⁻¹,
iii) a viscosity of at least 14,000 cps at a shear rate of 30 s⁻¹, and
iv) a viscosity of at least 9,000 cps at a shear rate of 60 s⁻¹,
b) at a temperature of 54° C.,
i) a viscosity of at least 37,000 cps at a shear rate of 1 s⁻¹,
i) a viscosity of at least 8,000 cps at a shear rate of 10 s⁻¹,
ii) a viscosity of at least 5,500 cps at a shear rate of 30 s⁻¹, and
iii) a viscosity of at least 4,400 cps at a shear rate of 60 s⁻¹, and
c) at a temperature of 71° C.,
i) a viscosity of at least 45000 cps at a shear rate of 1 s⁻¹
ii) a viscosity of at least 7000 cps at a shear rate of 10 s⁻¹,
ii) a viscosity of at least 4000 cps at a shear rate of 30 s⁻¹, and
iii) a viscosity of at least 3000 cps at a shear rate of 60 s⁻¹.

The snack or other food bar according to the invention optionally comprises at least three directly adjacent filling layers.

One or more of the filling layers are preferably a peanut creme. In addition to peanut cremes, the filling layers may be comprised of ingredients such as fudge, marshmallow and fruit filling. Filling layers herein are semisolid and pliable at the time of application, as opposed to the base layers used in formation of the bars such as granola layers, cookie piece layers, cracker layers, bread layers, wafer layers or pretzel layers, which are substantially firm upon application. The base layers form slabs. Examples of suitable filling layers herein are the peanut creme layer, fruit filling layers such as strawberry, grape, apple, banana, raspberry, blueberry, mixed berry, nectarines, oranges, pineapples etc., marshmallow, fudge, caramel, butterscotch, icings, sandwich cookie creme fillings such as those which might be used in sandwich cookies, and banana creme.

One or more of the filling layers may be a fruit filling stably at 72° F. incorporated into the bar.

The snack or other food bar according the invention preferably comprises an external coating, a peanut creme layer and a fruit filling layer, the peanut creme layer not being immediately adjacent the external coating. The coating may be a confectionery coating, such as chocolate, or other confectionery coatings such as and chocolate-flavored, peanut butter-flavored, caramel-flavored and yogurt-flavored confectionery coatings (i.e., coatings not meeting the standard of identity for chocolate). The coating may cover all or part of the bar, e.g., the top or the sides, can be coated. If desired, the coating may include nutrient additives such as protein, calcium, vitamins, and other minerals. The coating may be imparted to the bar in several ways, e.g., by enrobing or dusting.

The food bar may additionally comprise a layer which includes granola, and, for instance, the layer of peanut creme adjacent the granola layer, and a filling layer adjacent the peanut creme layer. The granola layer may comprise chewy granola.

To minimize water migration, the peanut creme preferably has a water activity (Aw) of from 0.35-0.5 and the layer directly adjacent the peanut creme layer may be a fruit filling layer having a water activity (Aw) of 0.4-0.6.

In a further aspect, the invention is directed to a process for making a food bar comprising:
a) forming a base layer;
b) applying a filling layer above the base layer;
c) applying a second filling layer directly above the first filling layer;
d) cooling the combined layers; and
e) applying a further layer or coating above the second filling layer.

One or more of the filling layers are preferably the peanut or other nut creme of the invention. The base layer may be formed by mixing together cereal and binder. For instance, the base layer may be formed by cooking a binder syrup, combining said binder syrup with dry grains, and mixing the binder syrup with the grains.

Preferably, in the bar of the invention, the peanut creme layer is not immediately adjacent the external coating. This minimizes the likelihood of undesirable exchange of components, such as oil or moisture, between the peanut creme layer and the external coating layer at ambient temperatures, i.e., 72° F. In a still further preferred embodiment, the food bar of the invention comprises a cereal layer which preferably includes granola, a layer of peanut creme adjacent the granola layer, and another filling layer adjacent the peanut creme layer. In addition to peanut creme, filling layers are preferably fruit filling such as strawberry, grape, apple, banana, raspberry, blueberry, mixed berry, etc. but also may be marshmallow, fudge, caramel and others.

In a further embodiment, a second granola or other cereal layer is used adjacent to an additional filling (eg, fruit filling) layer on the opposite side from the peanut creme layer. It generally will comprise free-flowing particles of dehydrated marshmallows and/or granola or other cereal (e.g., crisp rice, wheat flakes, soy crisps, etc.) which are applied to the surface through a waterfall-type application. The second granola layer is capable of absorbing minor amounts of oil/moisture which could migrate from the peanut layer or other filling layer to prolong storage stability of the product.

In preferred embodiments, the fruit filling is a low moisture fruit filling

Preferably the apparent yield stress of the peanut creme of the invention is greater than 25,000 dynes/cm², 40,000 dynes/cm², especially greater than 60,000 dynes/cm², more preferably greater than 70,000, 80,000 or even higher.

While many aspects of the invention herein are described with reference to a peanut crème, other nut cremes such as walnut crème, cashew crème, almond crème, macadamia nut creme, and pistachio nut crème, may be suitable, as well.

The food bar of the invention may be suitable for snacks or other purposes such as meal replacement, weight loss or energy.

For a more complete description of the above and other features and advantages of the invention, reference should be made to the following description of the preferred embodiments

### BRIEF DESCRIPTION OF THE DRAWINGS

FIG. 1 is a graph showing viscosity in cps at 32° C. versus shear rate in 5-1 for a commercially available creamy peanut butter and a peanut creme according to the invention.

FIG. 2 is a graph showing viscosity in cps at 54° C. versus shear rate in s-1 for a commercially available creamy peanut butter and a peanut creme according to the invention.

FIG. 3 is a graph showing viscosity in cps at 71° C. versus shear rate in s⁻¹ for a commercially available creamy peanut butter and a peanut creme according to the invention.

FIG. 4 is a graph showing stress growth for a commercially available creamy peanut butter.

FIG. 5 is a graph comparing crystallization after cooling for a commercially available creamy peanut butter and a peanut creme according to the invention.

### DETAILED DESCRIPTION OF THE INVENTION

The food bar of the invention will generally comprise a base layer which includes one or more cereals. Such cereals may include puffed rice, wheat flakes, granola, corn flakes, flax, teff, crisp rice, soy, and oats. The cereal layer is held together by a binder which will be described below.

In addition to the cereal and the binder, the cereal layer may comprise optional ingredients such as various types of nuts, dehydrated fruit bits, chocolate chips, peanut butter bits or chips, marshmallows, cookie pieces, graham cracker pieces or crumbs, candy (whole or bits) and the like.

The binder will generally include fat and sugar and optionally an emulsifier. Fats or oils which may be used are described below. A preferred oil is canola oil, although partially hydrogenated oils which are semi-solid at room temperature would also be applicable and may be more stable than canola oil. Preferably the oils are liquid at room temperature. In addition to canola, soy or other vegetable oils may be used, either partially hydrogenated or non-hydrogenated. Sugars and other polyols which can be used in the binder are described below among the carbohydrates and the bulking agents which are useable in the food bar. Especially preferred are corn syrup, high fructose corn syrup, sucrose, high maltose corn syrup, glycerine, maltitol, sorbitol, xylitol, mannitol, lactitol, maltodextrin, and fructose.

Emulsifiers which are useful in the binder of the invention are described below. Especially preferred is lecithin.

The binder is preferably prepared as a syrup in two parts, as a base and a flavor binder syrup. The flavor binder syrup may include color such as caramel color and flavors such as peanut flavor. The base syrup is made and heated to dissolve all of the sugars and obtain a uniform syrup. The flavor is added after the syrup is cooled to help prevent evaporation of the volatile compounds of the flavor.

The food bars of the invention preferably include a peanut or other nut creme layer. The peanut creme layers of this invention may, if so desired, fully comply with the FDA standard of identity for peanut butter applicable as of Jan. 1, 2003. This requires that the standardized product contain a minimum of 90 percent ground roasted peanuts, no artificial flavor, and no more than 10 percent of optional seasoning and stabilizing ingredients such as salt, nutritive sweeteners and hydrogenated vegetable oils and emulsifiers such as mono- and diglycerides. Alternatively, however, if desired, other products may be used which would be known as peanut spreads, artificial peanut butter or by other names so long as they are spreadable to form a layer. All of the above are referred to herein as “peanut cremes.” The percent by weight of peanuts can range from upward of 50%, from 50 to 90% for nonstandard spreads and from 90 to 95% and higher for standard peanut butters.

The peanut or other nut layer of the invention may include high melting vegetable oil stabilizers of palm, cottonseed and similar vegetable oil origins at a level of form 0.5 to 10 percent, preferably from 1 to 5%. The high melting (145°-155° F.) vegetable oil stabilizer levels, especially of palm, cottonseed and similar vegetable oil origins, may be from 0.25 to 4.0 percent, preferably up to 1.75 percent, especially from 0.5 to 1.25%. Hydrogenated mono- and di-glycerides are preferred. The stabilizer tends to reduce liquid oil separation and to improve the viscosity of the product.

Appropriate seasonings and stabilizing ingredients for the peanut creme include the following and combinations thereof; salt, sugar, liquid sugar, dextrose, honey, fructose, corn syrup, medium invert and invert sugars, maple syrup, molasses, liquid or powder, peanut oil, particularly high flavor oil extracted from roasted peanuts, vegetable oils, fractionated vegetable oils and partially hydrogenated vegetable oils, including soybean, palm, coconut, cottonseed, corn, rapeseed, canola and peanut oils, saturated and unsaturated mono- and diglycerides and lecithin, polyglycerol esters and other food emulsifiers. It is preferred that the seasonings and stabilizing ingredients added to the peanuts do not exceed the 10% limit imposed by the Standards of Identity for peanut butter. In particular, the seasonings and stabilizers preferably constitute from 0.5 to 10%. The peanut creme may include flavors such as chocolate or other flavors.

The peanut creme may include particulates such as nuts so long as the peanut crème remains semisolid. Preferably the peanut crème, including all ingredients such as partculates, falls within the viscosity parameters discussed herein.

If needed, dried powdered molasses may be added to improve the color of the final peanut creme layer product. A suitable powdered molasses is Dri-Mol Molasses Powder from ADM Specialty Ingredients—Bakery, Decatur, Ill.

The mixture of peanuts, seasonings and stabilizers may be ground into a fine paste via the use of milling equipment which is standard in the peanut butter industry, such as a Bauer and/or an Urshel mill. The milled peanut butter paste may be collected in a standard feed or supply tank fitted with a vacuum system to de-aerate the milled paste from any entrapped or entrained atmospheric air. It may also be de-aerated prior to milling.

As supplement and to boost further the flavor intensity, a high flavor peanut oil may be used in the peanut creme of the invention. The high flavor peanut oil is obtained by the extraction of oils from dark roasted peanut. As example of a high flavor peanut oil suitable for use herein is Golden Premium #504505 from Golden Peanut Company of Alpharetta, Ga. The high flavored peanut oil may be added at levels of 0.5 to 3.0% of the peanut creme layer.

The peanut creme may optionally be supplemented with one or more of: tocopherols at a level of 0.1 to 0.3 wt % (antioxidant), peanut flavor at a level of 0.5 to 3 wt %, peanut flour at a level of 5 to 10 wt % and an emulsifier, such as one of those listed below, at a level of 0.5 to 3 wt %.

It has been found that when the peanut creme falls within the viscosity parameters given above, particularly the preferred parameters, it sets very quickly after being deposited in the molten state atop a base or other layer. This permits preservation of the organoleptic characteristics of peanut creme or peanut butter which can then be perceived by the consumer when he or she consumes the bar.

While particularly useful in making food bars, it is believed that the peanut creme will find use in other products, particularly where it is desired to use multiple, adjacent, layers of peanut-containing products and where it is desired to preserve the unique organoleptic properties of the peanut creme or peanut butter.

The food bar of the invention may include as one or more of the filling layers a fruit filling layer. The fruit filling layer may be a low moisture fruit filling. Examples of suitable fruits include strawberries, grapes, and apples, berries, nectarines, oranges, and pineapples. The source of the fruit may include puree, fruit juice, fruit juice concentrate, flakes, or powders. Fruit filling layers or other filling layers may be flavored with natural or artificial fruit flavors.

In accordance with one aspect of the invention it has been found that in order to promote stability of the peanut creme and fruit filling layers certain defined water activities should be present. All filling layers, e.g., the peanut creme and any fruit filling layer, preferably have a water activity of from 0.1 to 0.6.

In accordance with another aspect of the invention, the food bar is coated on one or all sides. It is especially preferred that the peanut creme layer not be immediately adjacent the coating, to promote stability of the product. For example, the fruit filling or other filling layer or a particulate layer is preferably interposed between the peanut creme layer and any coating.

Suitable coatings include confectionery coatings and non-confectionery coatings. The coatings surround messy or sticky components and facilitate eating.

To fortify the bar, in addition to vitamins and other minerals, calcium may preferably be present in the food bars at from 100 mg to 200 mg, per 35 g bar. A preferred calcium source is tricalcium phosphate.

For proteins and other macro- and micro-nutrients, it may be desirable to include a percentage of the daily value, such as 10%, 15% or more. Daily value refers to the RDI or the DRV for the respective macro- or micro-nutrient as found in Volume 21 of the US Code of Federal Regulations effective for Jan. 1, 2003, which is hereby incorporated by reference.

The food bar of the invention may include protein sources. Preferred sources of protein include sources of whey protein such as whey protein isolate and whey protein concentrate and sources of rice protein such as rice protein concentrate. Soy protein or soy protein concentrate may also be used. The protein may be present in the food in discrete nuggets or crisps, in other forms such as dry powder. Additional protein sources include one or more of dairy protein sources, such as dry whole milk, whey, casein, milk solids non-fat, etc. The dairy source may contribute dairy fat and/or non-fat milk solids such as lactose and milk proteins, e.g. whey proteins and caseins. Protein concentrates such as one or more of whey protein concentrate, milk protein concentrate, caseinates such as sodium and/or calcium caseinate, isolated soy protein and soy protein concentrate may be used. Total digestable protein levels within the food bars of the invention are preferably within the range 5-12 grams digestable protein per bar, especially 5-7 g digestable protein per bar.

The food bar of the invention may include oils or fats in any of the layers, but especially in the binder for the base or other cereal layers and in the peanut creme. The source for any fat used in the food bars is preferably vegetable fat, such as for example, cocoa butter, palm, palm kernal, soybean, safflower, cottonseed, coconut, rapeseed, canola, corn, peanut and sunflower oils, or mixtures thereof. However, animal fats such as butter fat may also be used if consistent with the desired nutritional profile of the product. Preferably the amount of fat in the food bar is not more than 35 wt. %, especially not more than 40 wt. %, preferably from 20 to 30 wt. %. It is preferred that the fat employed in the bar is a low trans fat, especially a no-trans fat. For instance, it is preferred that the percentage by weight of fatty acid moieties having one or more trans double bonds is less than 2 percent of the weight of the bar, especially less than 1.5 wt %. If desired, the coatings may be low- or no-trans.

Flavorings are preferably added to the food bar in amounts that will impart a mild, pleasant flavor. Especially useful are peanut flavors. The flavoring may be any of the commercial flavors employed in food bars or other foods, such as varying types of cocoa, pure vanilla or artificial flavor, such as vanillin, ethyl vanillin, chocolate, malt, mint, peanut butter, yogurt powder, extracts, spices, such as cinnamon, nutmeg and ginger, mixtures thereof, and the like. It will be appreciated that many flavor variations may be obtained by combinations of the basic flavors. The food bars are flavored to taste. Suitable flavorants may also include seasoning, such as salt, and imitation fruit or chocolate flavors either singly or in any suitable combination.

Typically, the peanut creme will have an emulsifier at a level of from 0.5 to 3%, especially from 1 to 2%. Emulsifiers may also be present in other layers.

Typical emulsifying agents may be phospholipids and proteins or esters of long chain fatty acids and a polyhydric alcohol. Lecithin is an example. Fatty acid esters of glycerol, polyglycerol esters of fatty acids, sorbitan esters of fatty acids and polyoxyethylene and polyoxypropylene esters of fatty acids may be used but organoleptic properties, or course, must be considered. Mono- and di-glycerides are preferred. The emulsifiers may be present in the food bar at levels overall of about 1% to 4%, preferably 2% to 3%. Emulsifiers may be used in combination, as appropriate.

If desired fiber, may be included in the food bars of the invention. Among fiber sources which may be included in the foods of the invention are fructose oligosaccharides such as inulin, guar gum, gum arabic, gum acacia, oat fiber, cellulose and mixtures thereof. The compositions preferably contain at least 2.5 grams of fiber per serving, especially at least 3 grams of fiber per serving. Preferred serving size for the bars of the invention is 35 grams.

Typically, the food bar will be naturally sweetened. Sweetener will generally be included in the binder at a level of 20 wt % to 95 wt %, from 20 to 30 wt % for low sugar applications and from 80 to 95 wt % for regular applications. Natural sources of sweetness include sucrose (liquid or solids), glucose, fructose, and corn syrup (liquid or solids), including high fructose corn syrup and high maltose corn syrup and mixtures thereof. Other sweeteners include lactose, maltose, glycerine, brown sugar and galactose and mixtures thereof.

If it is desired to use artificial sweeteners, any of the artificial sweeteners well known in the art may be used, such as aspartame, saccharine, Alitame® (obtainable from Pfizer), acesulfame K (obtainable from Hoechst), cyclamates, neotame, sucralose, mixtures thereof and the like. The artificial sweeteners are used, if at all in varying amounts of about 0.01 to 0.3 wt % of the bar.

### EXAMPLE 1

### Prophetic

1) Binder Syrup Preparation

Liquid ingredients, including high maltose corn syrup and high fructose corn syrup, lecithin, and canola oil are combined with the dry ingredients, sugar, maltodextrin, fructose, and salt. The slurry is heated to 180° F. to 200° F. to dissolve all dry ingredients. The slurry is then cooled and held at 1200 to 130° F. After slurry has cooled, liquid peanut flavor, Vitamin E and optionally caramel color, are added to the slurry.

2) Peanut Butter Layer Preparation

Creamy peanut butter is heated to 165-180° F. to enable blending of emulsifier and partially defatted peanut flour. The emulsifier is a hydrogenated mono- and di-glyceride having an IV of 3 sold under the designation BFP74 K by American Ingredients Company of Kansas City, Mo. The mixture is heated to 165-180° F. to fully melt all of the fat in the system (including the emulsifier). The mixture is cooled/maintained at 145-155° F., at which time, peanut flavor and vitamin E may be added. The peanut layer material is cooled just prior to application using a scraped surface heat exchanger to 80-105° F.

3) Granola Base Mixing

Grains, including puffed rice, wheat flakes and granola are weighed and combined with heated binder syrup and peanut butter (120-125° F.) in a manner that minimizes breakage of the grains and provides an even distribution of cereal grains, binder syrup and peanut butter

4) Base Layer (Granola) Deposition/Rolling

The product of step 3 is deposited onto a moving belt where rollers flatten and compress the grain mass into a cohesive structure. The grains are kept intact (as much as possible), but are compressed into a firm slab upon which the peanut butter layer and fruit fillings can be deposited. Voids or gaps in the granola slab are preferably avoided.

5) Peanut Butter Layer Application

The peanut butter or peanut creme layer is applied in a ribbon to the full width of the granola layer at a uniform thickness of from 2-5 mm thickness

6) Fruit Filling/Other Filling Layer Application

Fruit filling/marshmallow cream is applied atop the peanut creme layer to the full width of the granola layer at a uniform thickness from 2-5 mm.

7) Cooling

The entire slab is cooled to obtain proper texture/firmness to the peanut butter or peanut creme and fruit layers to about 70° F. to permit a clean cutting operation.

8) Topping Depositor (Before or After Cooling)

Before or after cooling, puffed rice is continuously applied in a single layer to the surface of the product. A roller, just downstream of the topping applicator is used to set the particulates into the surface layer. Examples of other particles which can be added at this stage include one or more of puffed rice, granola, marshmallow, dried fruit and other particulate.

9) Slitter/Guillotine

The product is slit into ribbons parallel to the belt direction with a narrow side trim that is cut off and removed from the main slab. The bars are cut to a width of 20-30 mm. The side trim is to be reworked into the main mass of step 3. Bars are then cut using a guillotine cutter to a length of 8-14 cm

10) Enrobing

A confectionery coating (chocolate, peanut butter, yogurt or other flavored confectionery coating) is applied to the outside of the finished bar, preferably at a level of 20 to 40 wt %, using enrobing equipment.

11) Cooling

The product is cooled to 50-65° F. to firm coating, peanut layer and fruit filling, after which the product is packaged.

The composition is presented in Table 1.

TABLE 1

| | | | Calc. % Wt. |
|---|---|---|---|
| Step # | Description | Ingredient | of Bar |
| 1 | Base Granola Bar | Toasted oats | 5.0 |
| | | Mini wheat flakes | 0.8 |
| | | Crisp rice | 8.4 |
| | | Binder syrup | 19.0 |
| | | Glycerine | 0.5 |
| | | Flavor | 0.2 |
| 2 | Peanut butter | Skippy creamy peanut butter | 17.1 |
| | Preparation | Mixed tocopherols | 0.01 |
| | | Peanut flavor | 0.1 |
| | | 12% defatted drk. roast pnt. | 1.5 |
| | | flour | |
| | | Emulsifier | 0.4 |
| 4 | Fruit filling | Strawberry filling | 15.0 |
| 5 | Final Assembly/ | Crisp rice | 2.0 |
| | enrobing | Dark roast peanut flavored | 30.0 |
| | | coating | |
| | | TOTAL | 100.0 |

### EXAMPLE 2

### Prophetic

Viscosities for molten peanut butter are measured using the following procedure. Experiments are conducted on Haake Rheometer using Model Rotovisco RV20. Measurements are taken on a set of concentric cylinders with an inner cylinder diameter of 2.02 cm and a length of 1.96 cm at 1 mm. annual gap.

Samples are pre-heated to 80 C for ten minutes to remove residual crystals prior to cooling down to 71, 54, and 32° C. respectively.

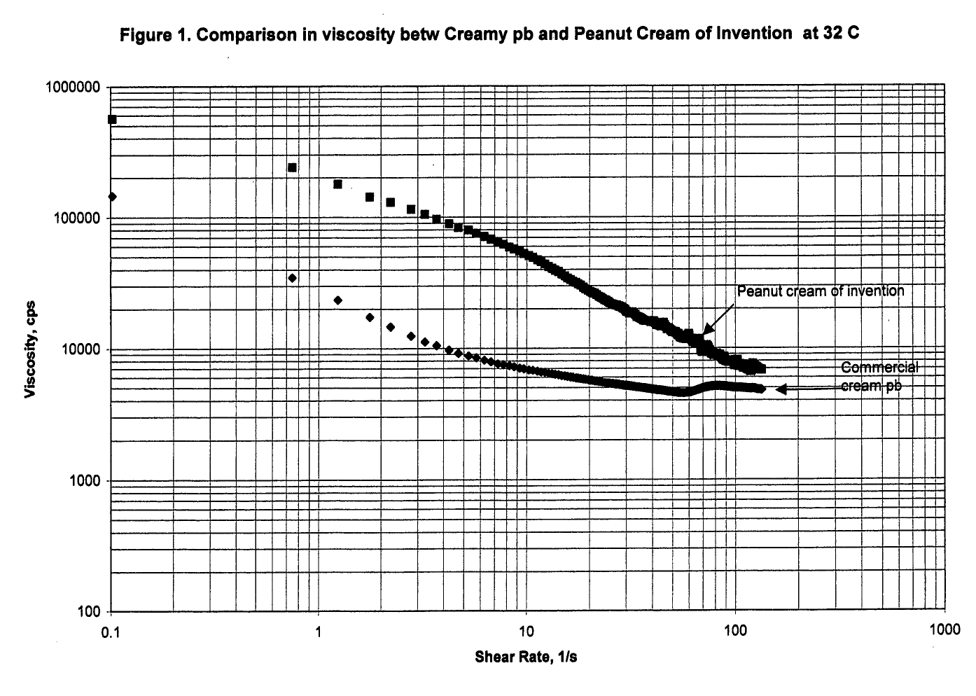

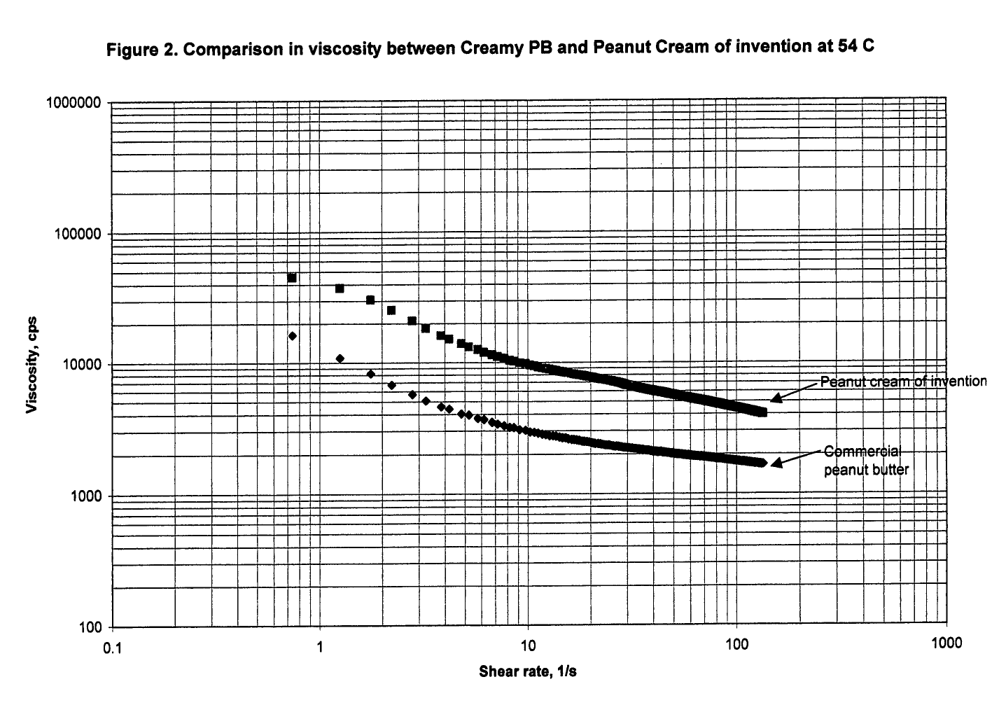

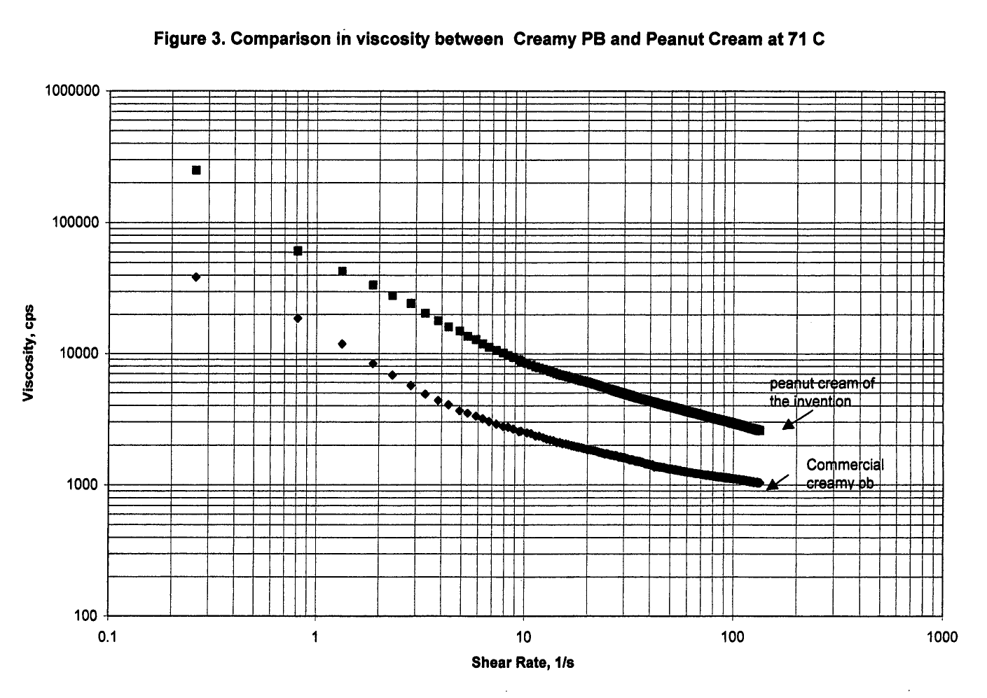

Values in viscosity vs shear rate are determined by increasing the shear rate¹ from 0 to 134 s⁻¹ in about 9 minutes. Results for a commercially available creamy butter and a peanut cream according to the invention are shown in FIGS. 1-3. Viscosity data can be regressed with a rheological model:
Casson Model; τ^{0.5}=τ₀^{0.5}+η^{0.5}*γ^{0.5} where τ is shear stress, τ₀ is the Casson Yield Stress, η
   ¹Shear rate is defined as the relative velocity between cylinders divided by the annual gap

Is Casson Viscosity, and γ is the shear rate.

### EXAMPLE 3

### Prophetic

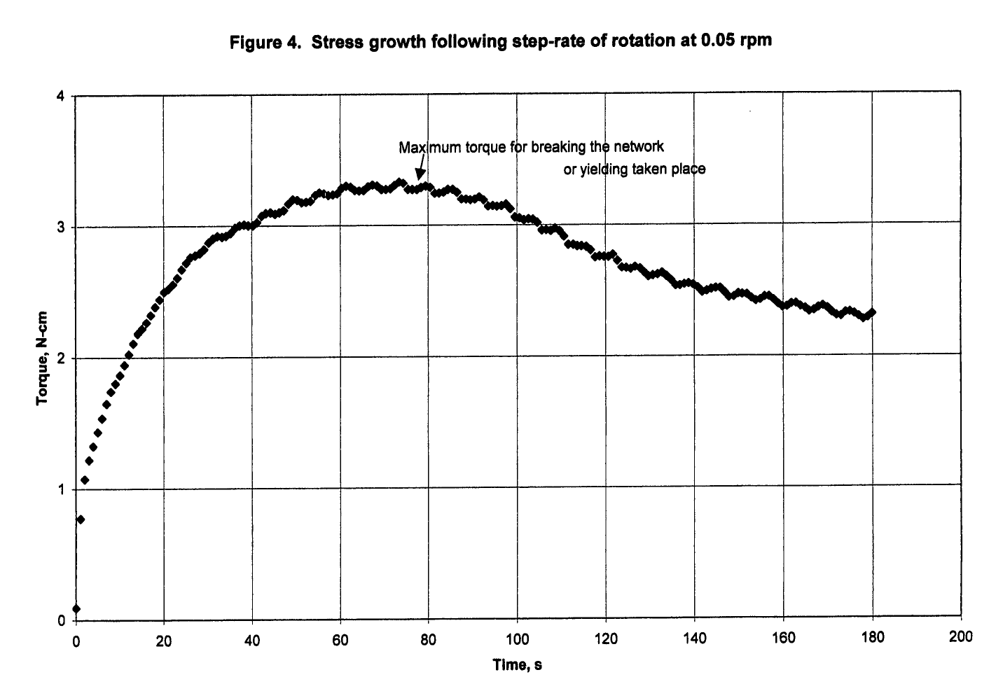

Yield stress of products at room temperature is determined using a vane on a Haake Rheometer. As the yield stress is exceeded, flow commences. Below the yield stress, the product deforms. A shear stress growth curve as shown in FIG. 4 following a step rate of rotation at 0.05 rpm is provided for a well-know commercial brand of creamy peanut butter. The yield stress is calculated using the maximum torque value and geometry of the vane.

Apparent viscosity vs shear rate is determined for using the squeezing-flow method. Apparent yield stress is determined by multiplying the viscosity and its corresponding shear rate. The apparent yield stress is 20,000 dynes/cm² for the well-known commercial peanut butter brand and 80,000 dynes/cm² for a product according to the invention. In addition, the viscosity of the product according to the invention is nearly 1.75 times that of the well-known commercial peanut butter brand.

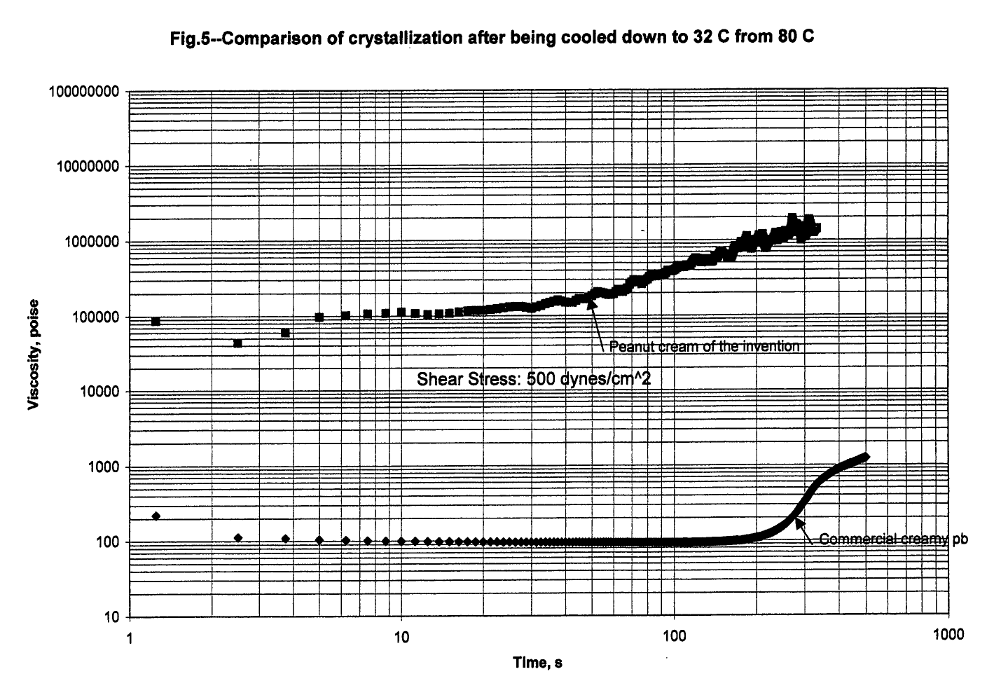

A comparison of the crystallization and flow behavior between a product according to the invention and a well known creamy peanut butter product at 32° C. is shown in FIG. 5. The experiments are conducted using Rheometrics Dynamic Stress Rheometer on a set of 25 mm (in Diameter) parallel plates.

Samples are cooled down to 32° C. from 80° C. after being held for ten minutes for removal of residual crystals, a 500 dyne/cm² shear stress is immediately applied and a creep experiment is conducted. Viscosity vs time is then determined from creep test.

An initial decrease in viscosity is associated with flow alignment of the particles immediately being subjected to the shear stress. The increases in viscosity at later times are associated with stress induced crystallization. This happens on both products: for the commercial creamy peanut butter, the induction time² is about 200 s vs 50 s. However, prior to crystallization, the viscosity of the peanut creme of the invention is about 3 orders of magnitude higher as soon as the temperature is reached 32° C.
²The time required between on-set of crystallization and that of stress being applied.

### EXAMPLE 4

### Prophetic

A peanut creme is made using the following ingredients by adding the ground roasted peanuts, the salt, the sugar and the partially hydrogenated vegetable oil, grinding to make creamy peanut butter, and then following the process of Example 1 to make a snack bar:

| Ingredient | % by Weight |
|---|---|
| Ground Roasted Peanuts | 82.1 |
| Peanut flour (12% defatted) | 7.5 |
| Salt | 1.1 |
| Sugar 6X | 5.3 |
| Partially Hydrogenated Veg oil | 1.5 |
| Emulsifier (mono- and | 1.8 |
| di-glycerides) | |
| Mixed Tocopherols | 0.06 |
| Peanut flavor | 0.6 |
| | 100 |

It should be understood of course that the specific forms of the invention herein illustrated and described are intended to be representative only, as certain changes may be made therein without departing from the clear teaching of the disclosure. Accordingly, reference should be made to the appended claims in determining the full scope.

What is claimed is:

1. A food bar comprising at least two directly adjacent filling layers.

2. The food bar according to claim 1 comprising at least three directly adjacent filling layers.

3. The food bar according to claim 1 wherein each of said filling layers is independently selected from the group consisting of peanut creme, fudge and fruit filling.

4. The food bar according to claim 1 wherein at least one of said filling layers is a peanut creme layer.

5. The food bar according to claim 1 wherein two said directly adjacent filling layers are peanut creme layers.

6. The food bar according to claim 2 wherein each of said three directly adjacent filling layers is a peanut creme layer.

7. The food bar according to claim 1 further comprising an external coating, a peanut creme layer and a fruit filling layer, said peanut creme layer not being immediately adjacent said external coating.

8. The food bar according to claim 4 comprising:
a layer comprising granola, said layer of peanut creme adjacent the granola layer, and a filling layer adjacent the peanut creme layer.

9. The food bar according to claim 8 wherein said granola layer is a chewy granola layer.

10. The food bar according to claim 8 wherein said filling layer adjacent said peanut creme layer is selected from the group consisting of fruit filling, marshmallow and fudge.

11. The food bar according to claim 4 wherein the peanut creme has a water activity (Aw) of from 0.3-0.5 and wherein said layer directly adjacent said peanut creme layer is a fruit filling layer having a water activity (Aw) of 0.40-0.60.

12. The food bar according to claim 1 wherein said bar is enrobed with a coating.

13. The food bar according to claim 12 wherein said coating is a confectionery coating.

14. The food bar according to claim 8 further comprising a second granola layer adjacent to said fruit filling layer.

15. The food bar according to claim 1 wherein the sides of said bar are coated with a coating.

16. A process for making a food bar comprising:
f) forming a base layer;
g) applying a filling layer above the base layer;
h) applying a second filling layer directly above the peanut creme layer;
i) cooling the combined layers; and
j) applying a further layer or coating above the second filling layer.

17. The process according to claim 16 wherein said base layer is formed by mixing together cereal and binder.

18. The process according to claim 17 wherein said base layer is formed by cooking a binder syrup, combining said binder syrup with dry grains, and mixing the binder syrup with the grains.

19. The process according to claim 18 further comprising mixing peanut creme with said mix of binder syrup and grains.

20. The process according to claim 16 wherein said base layer comprises a slab formed by subjecting mixed base layer ingredients to compression by a series of compression rollers.

21. The process according to claim 16 wherein cooling is effected through a cooling tunnel.

22. The process according to claim 16 wherein the coating is applied using an enrober.

23. The process according to claim 16 wherein at least one of said filling layers is a peanut creme.

24. The process according to claim 23 wherein said two filling layers are peanut cremes.

25. The process according to claim 16 further comprising a third filling layers directly adjacent one of said first or second filling layers.

26. The process according to claim 16 wherein said peanut creme is cooled to within the range of 80 to 105° F. prior to application.

27. The food bar according to claim 4 wherein the peanut creme comprises:
at least 50 wt % peanuts,
optionally vegetable oils, and
optionally seasoning and/or stabilizing ingredients, said ingredients being ground into a creme and said creme having
a) at a temperature of 32° C.,
i) a viscosity of at least 50,000 cps at a shear rate of 1 s⁻¹,
ii) a viscosity of at least 10,000 cps at a shear rate of 10 s⁻¹,
iii) a viscosity of at least 7,000 cps at a shear rate of 30 s⁻¹, and
iv) a viscosity of at least 6,000 cps at a shear rate of 60 s^{-1,}
b) at a temperature of 54° C.,
i) a viscosity of at least 17,000 cps at a shear rate of 1 s⁻¹
ii) a viscosity of at least 4,000 cps at a shear rate of 10 s^{-1,}
iii) a viscosity of at least 2,400 cps at a shear rate of 30 s^{-1,}
iv) a viscosity of at least 2,100 cps at a shear rate of 60 s⁻¹, and
c) at a temperature of 71° C.,
i) a viscosity of at least 20,000 cps at a shear rate of 1 s⁻¹
i) a viscosity of at least 3,400 cps at a shear rate of 10 s⁻¹,
ii) a viscosity of at least 2000 cps at a shear rate of 30 s⁻¹, and
iii) a viscosity of at least 1600 cps at a shear rate of 60 s⁻¹.

28. The food bar according to claim 27 wherein said peanut creme has
a) at a temperature of 32° C.,
i) a viscosity of at least 100,000 cps at a shear rate of 1 s⁻¹
ii) a viscosity of at least 24,000 cps at a shear rate of 10 s⁻¹,
iii) a viscosity of at least 10,000 cps at a shear rate of 30 s⁻¹, and
iv) a viscosity of at least 8,000 cps at a shear rate of 60 s⁻¹,
b) at a temperature of 54° C.,
i) a viscosity of at least 30,000 cps at a shear rate of 1 s⁻¹,
ii) a viscosity of at least 6,500 cps at a shear rate of 10 s⁻¹,
iii) a viscosity of at least 4,400 cps at a shear rate of 30 s⁻¹, and
iv) a viscosity of at least 3,400 cps at a shear rate of 60 s⁻¹, and
c) at a temperature of 71° C.,
i) a viscosity of at least 34000 cps at a shear rate of 1 s⁻¹
ii) a viscosity of at least 6000 cps at a shear rate of 10 s⁻¹,
iii) a viscosity of at least 3000 cps at a shear rate of 30 s⁻¹, and
iv) a viscosity of at least 2400 cps at a shear rate of 60 s⁻¹.

29. The process according to claim 17 wherein prior to applying the further layer the bars are cut to size.
